(19) United States
(12) Patent Application Publication
(10) Pub. No.: US 2006/0255158 A1
(43) Pub. Date: Nov. 16, 2006

(54) Security card apparatus

(76) Inventors: Yanki Margalit, Ramat-Gan (IL); Dany Margalit, Ramat-Gan (IL)

Correspondence Address: DR. MARK FRIEDMAN LTD.;C/o Bill Polkinghorn, 9003 Florin Way, Upper Marlboro, MD, 20772, US

(21) Appl. No.: 11/125,183

(22) Filed: May 10, 2005

(51) Int. Cl. G06K 19/06

(52) U.S. Cl. 235/492

(57) ABSTRACT

The present invention is directed to a security card apparatus, comprising: a portable device coupled with a wired communication interface (e.g. USB, FireWire, RS232, parallel communication interface, serial communication interface); a substrate of a typical credit card or typical smart card format; and a shaft for connecting the portable device to the substrate such that the portable device can be rotated around the shaft for creating a state where the portable device can be connected to a host, and a state where the security card apparatus can be stored within a typical case for storing credit cards in a wallet. The substrate may comprise a figure of a user thereof.

### FIELD OF THE INVENTION

The present invention relates to the fields of business/credit cards and portable devices.

### BACKGROUND OF THE INVENTION

The term Portable Device refers herein as to a small device, which connects to a computerized system via a common computer interface such as USB and FireWire, and typically used for carrying out functionalities of personal nature in conjunction with the computer it connects to. Due to its small size, a portable device is easy to be carried by a user. Because of its portability it is usually used with relevance to activities of personal nature such as authentication and electronic wallet. Security tokens like Aladdin's eToken™, RSA's SecurID™ and SafeNet's iKey™, are portable devices. Generally, they provide security related functionalities such as encryption, decryption, secure storage, identification, etc. Portable Flash memory such as Disk-On-Key™ is also a portable device.

The term Security card apparatus (SCA) refers herein to a device of about a credit card size or business card size, which employs circuitry for performing activities of personal nature, and communicates with a host. A smart card is an example of SCA.

Currently smart cards are designed to communicate with a host via a smart card reader. Although the use of smart cards is common, computerized systems are rarely equipped with an interface to a smart card. Another way for communicating between a SCA and a host is by incorporating a display in the SCA, and enabling the user to type the content of the display on a keyboard of the host. This method is common in one-time-password applications. Due to the limited ways of communicating between a SCA and a host, SCAs are not common in authentication and security related activities.

A significant drawback of a smart card is that it can be connected to a host only via a smart card reader, whilst the personal computers distributed currently on the market usually do not comprise smart card readers. As a result, the use of smart cards doesn't maximize its potential.

Pending application for patent IL 166860, of the same applicant, presents a solution for the above detailed problems presented above by combining an SCA with a USB interface. It takes a few steps forward, and makes a connection between an SCA and any common computer interface, whether it is a wired or wireless, such as USB and FireWire.

One drawback of IL 166860 is that the components of the circuitry embedded in the security card apparatus may be thicker than the common or standard thickness of a smart card, which results in difficulty to store the SCA into a common wallet designed to store standard size and thickness credit cards.

Another drawback of smart cards is that impressing a picture of a user on a card cannot be carried out in parallel with setting the data thereof, e.g. user's identification data. Therefore smart cards usually do not comprise a picture of the user thereof.

It is an object of the present invention to provide a security card apparatus which enables to combine a portable device with a form factor of a credit card/smart card, and still corresponds to a typical wallet for credit/smart cards.

It is another object of the present invention to provide a security card apparatus, which enables impressing a picture on the card in parallel with setting the data of the card.

Other objects and advantages of the invention will become apparent as the description proceeds.

### SUMMARY OF THE INVENTION

The present invention is directed to a security card apparatus, comprising: a portable device coupled with a wired communication interface (e.g. USB, FireWire, RS232, parallel communication interface, serial communication interface); a substrate of a typical credit card or typical smart card format; and a shaft for connecting the portable device to the substrate such that the portable device can be rotated around the shaft for creating a state where the portable device can be connected to a host, and a state where the security card apparatus can be stored within a typical case for storing credit cards in a wallet. The substrate may comprise a picture of a user thereof.

According to one embodiment of the invention the portable device corresponds only to a certain substrate.

According to one embodiment of the invention the portable device is active only when connected to the substrate.

According to one embodiment of the invention a central system is notified of attempts to activate said portable device without being connected to a corresponding substrate.

A typical thickness of the substrate is about 0.8 mm, which is a typical thickness of a credit card. A typical thickness of the portable device is about 2.04 mm, which is combined of 1.9 mm of the typical thickness of the printed circuit on which the circuitry is mounted, and 0.5 mm of the plastic cover thereof.

### BRIEF DESCRIPTION OF THE DRAWINGS

The present invention may be better understood in conjunction with the following figures:

FIG. 1 schematically illustrates an SCA, according to a preferred embodiment of the invention.

FIGS. 2a and 2b is a perspective illustration two states of the SCA, according to a preferred embodiment of the invention.

FIGS. 3a and 3b schematically illustrate two states of the SCA, according to a preferred embodiment of the invention.

FIG. 4 illustrates a wallet in which an SCA 100, and credit cards 101 and 102 are stored.

### DETAILED DESCRIPTION OF PREFERRED EMBODIMENTS

The term Smart Card refers herein to a card about the size of a credit card, typically made of plastic, on which a microchip (also referred herein as Smart Card Chip) is embedded.

Typically a smart card chip comprises non-volatile memory and a CPU. The chip is designed such that an unauthorized object has to use a tremendous effort to disclose its content (including the content of the non-volatile memory) and/or structure. Therefore, a smart card chip can be considered as a secured facility.

Today smart cards are designed according to standards/common specifications thereof, e.g. ISO7816, and employ dedicated operating systems, such as MULTOS.

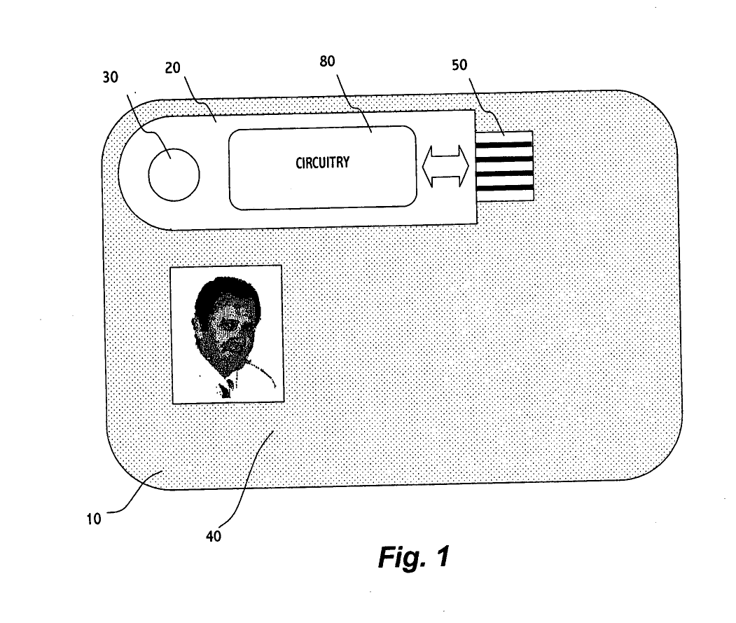

FIG. 1 schematically illustrates an SCA, according to a preferred embodiment of the invention. The SCA comprises a portable device 20 connected to a substrate 10 by a shaft 30. The substrate 10 is of a typical credit card or smart card typical format. The portable device 20 comprises circuitry 80, and a connector 50 through which the circuitry communicates with a host (not shown). The portable device 20 rotates around the shaft 30, in order to enable to connect the portable device 20 to a host (not shown) by the connector 50 (e.g. USB, FireWire, etc.). The SCA may comprise a picture 40, which typically is the picture of its owner.

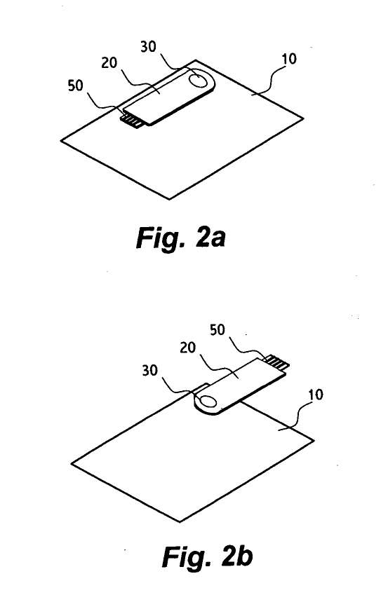

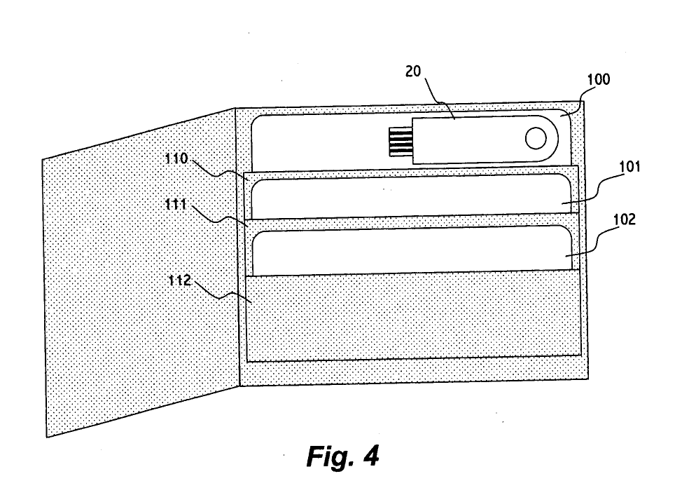

FIGS. 2a and 2b is a perspective illustration of two states of the SCA, according to a preferred embodiment of the invention. In FIG. 2a the portable device 20 is folded in order to enable to store the SCA into a wallet (see also FIG. 4). In the state illustrated on FIG. 2b the portable device 20 is rotated such a way that the connector 50 can be connected to a host (not shown).

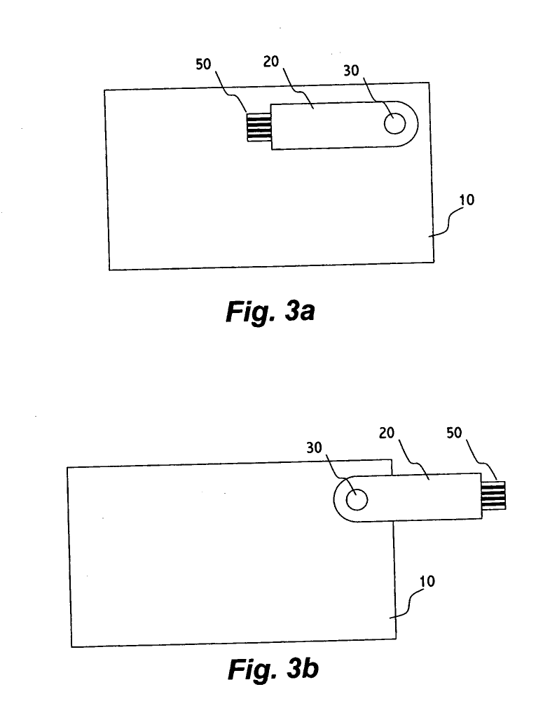

FIGS. 3a and 3b schematically illustrate two states of the SCA, according to a preferred embodiment of the invention. In FIG. 3a the portable device 20 is folded in order to enable to store the SCA into a wallet (see also FIG. 4). In the state illustrated on FIG. 3b the portable device 20 is rotated such a way that the connector 50 can be connected to a host (not shown).

FIG. 4 illustrates a wallet in which an SCA 100, and credit cards 101 and 102 are stored. The SCA 100 is stored in the case 110 and credit cards 101 and 102 are stored in cases 111 and 112 of the wallet correspondingly. Since the portable device 20 is located outside the case, the thickness of the portable device 20 does not create an obstacle to inserting the SCA 100 into the wallet, nor deforms the shape of the wallet.

The present invention enables to manufacture an SCA for an enterprise user such that the substrate 10 is manufactured by the “local authority” (i.e. the enterprise that issues the SCAs), and the portable device 20 is manufactured by the manufacturer of portable devices. This way the local authority can issue a card on request, without pre-coordination with the manufacturer of portable devices.

It should be noted that since the rotation of the portable device is not limited, a portable device 20 can be connected to any USB connector.

According to one embodiment of the invention, the portable device 20 suspends its activity when it gets disconnected from the substrate 10. According to one embodiment of the invention this is implemented by a conductive material impressed on the substrate 10, such as in a printed circuit. According to a further embodiment of the invention, the printed conductive part may comprise a physical property that can be sensed by the portable device 20, such as resistance of X Ohms. This way a portable device 20 can be active only if a corresponding substrate 10 is present. The substrate 10 may be uniquely associated with the portable device 20. According to a further embodiment of the invention, if a user tries to activate a portable device 20 more than a predetermined number of times when the substrate 10 is not present, the portable device 20 gets suspended. According to a further embodiment of the invention, a central system is notified about attempts to activate a portable device 20 without being coupled to a substrate 10. In this case the host to which the portable device connects to should be connected to the central system. Such a connection may be also through a network, e.g. the Internet.

Those skilled in the art will appreciate that the invention can be embodied by other forms and ways, without losing the scope of the invention. The embodiments described herein should be considered as illustrative and not restrictive.

1. A security card apparatus, comprising:
a portable device operationally coupled to a wired communication interface;
a substrate having a credit card format or a smart card format; and
an attachment mechanism whereby said portable device is attached to said substrate, said attachment mechanism providing a first state in which said portable device is deployed to be reversibly operationally connected to a host, and a second state in which said portable device is stowed so that the security card apparatus can be stored within a case.

2. An apparatus according to claim 1, wherein said mechanism is a shaft.

3. An apparatus according to claim 1, wherein said wired communication interface is selected from a group comprising: USB, FireWire, RS232, parallel communication interface, serial communication interface.

4. An apparatus according to claim 1, wherein said substrate comprises a figure of a user thereof.

5. An apparatus according to claim 1, wherein said portable device is uniquely associated with said substrate.

6. An apparatus according to claim 1, wherein said portable device is operative only when being connected to said substrate.

7. An apparatus according to claim 6, wherein a central system is notified of attempts to activate said portable device without being connected to a corresponding substrate.

8. An apparatus according to claim 1, wherein said substrate has a thickness of about 0.8 mm.

9. An apparatus according to claim 1, wherein said portable device has a thickness of about 2 mm.
